(19) United States
(12) Patent Application Publication
(10) Pub. No.: US 2009/0160638 A1
(43) Pub. Date: Jun. 25, 2009

(54) RADIO FREQUENCY IDENTIFICATION READER SYSTEM

(75) Inventor: Ronald D. Jesme, Plymouth, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/961,528

(22) Filed: Dec. 20, 2007

(51) Int. Cl. H04Q 7/00

(52) U.S. Cl. 340/539.11

(57) ABSTRACT

In general, the disclosure describes a radio frequency identification (“RFID”) reader system is disclosed. In particular, the RFID reader system is preferably mobile and determines both the existence and general location of at least one RFID-tagged object of interest.

### TECHNICAL FIELD

The present invention relates to a radio frequency identification (“RFID”) reader system. In particular, the RFID reader system is preferably portable and determines both the existence and general location of at least one RFID-tagged object of interest.

### BACKGROUND OF THE INVENTION

Radio-Frequency Identification (RFID) technology has become widely used in virtually every industry, including transportation, manufacturing, waste management, postal tracking, airline baggage reconciliation, and highway toll management. RFID systems are often used to prevent unauthorized removal of articles from a protected area, such as a library or retail store.

An RFID system often includes an interrogation zone or corridor located near the exit of a protected area for detection of RFID tags attached to the articles to be protected. Each tag usually includes information that uniquely identifies the article to which it is affixed. The article may be a book, a manufactured item, a vehicle, an animal or individual, or virtually any other tangible article. Additional data as required by the particular application may also be provided for the article.

To detect a tag, the RF reader outputs RF signals through an antenna to create an electromagnetic field within the interrogation corridor. The field activates tags within the corridor. In turn, the tags produce a characteristic response. In particular, once activated, the tags communicate using a pre-defined protocol, allowing the RFID reader to receive the identifying information from one or more tags in the corridor.

Various radio frequency (“RF”) antennas and RFID systems are known, for example: U.S. Pat. No. 4,012,740, U.S. Pat. No. 6,486,780, U.S. Pat. No. 5,030,959, JP Patent Publication 2006-050477, JP Patent Publication 2005-269403, JP Patent Publication 2005-195341, GB Patent Publication 2,388,963.

Although the commercial success of available RFID reader systems has been impressive, it is desirable to further improve the performance of existing portable RFID systems to provide more information to a user than just the existence of an item of interest.

### SUMMARY OF THE INVENTION

One aspect of the present invention provides a portable radio frequency identification (“RFID”) reader system. The portable RFID reader system for assisting a user in locating at least one RFID-tagged object of interest comprises: a computer; a user interface; an RFID reader; and an antenna for creating an electromagnetic field, where the antenna can electronically switch between a lobe field arrangement and a null field arrangement to determine the existence and the general, relative location of an RFID-tagged object of interest.

Another aspect of the present invention provides an alternative portable RFID reader system. The portable RFID reader system for assisting a user in locating at least one RFID-tagged object of interest, comprises: a computer; a user interface; an RFID reader; an antenna array for creating an electromagnetic field, where the antenna array comprises a first radio frequency (“RF”) element and a second RF element, where the first RF element and the second RF element are driven in phase to create a lobe field arrangement, where the first RF element and the second RF element are driven out of phase to create a null field arrangement, and where the antenna array can be electronically switched between the lobe field arrangement and the null field arrangement to determine the existence and the general, relative location of an RFID-tagged object of interest.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of one embodiment of a portable RFID reader system of the present invention;

FIG. 2 is a side view of the RFID reader system of FIG. 1 with a portion of the base housing removed;

FIG. 3 is a block diagram of the RFID reader system of FIG. 1;

FIG. 4 is an antenna pattern illustrating both a lobe field arrangement and a null field arrangement;

FIG. 4a is a three-dimensional diagram illustrating the null field arrangement of FIG. 4;

FIG. 4b is a three-dimensional diagram illustrating the lobe field arrangement of FIG. 4;

FIG. 5 illustrates a schematic view of the RFID reader system of FIG. 1 including both a lobe field arrangement and null field arrangement;

FIGS. 6A-6C illustrates a schematic view of the RFID reader system of FIG. 1 providing a lobe field arrangement and null field arrangement in three different positions;

FIG. 7a illustrates a schematic elevational view of a room with several RFID-tagged items; and

FIG. 7b illustrates a view like FIG. 7a including a path which minimizes travel time for a user of the RFID reader system of the present invention.

### DETAILED DESCRIPTION OF THE INVENTION

In general, various RF antennas and RFID systems are known for determining the existence of a particular item of interest, usually having an RFID tag associated with it. However, few systems determine the actual location of the RFID-tagged item relative to the user is looking for and provide direction to the user to find the item they are seeking. The RFID reader system of the present invention assists the user in both determining the existence of the RFID-tagged item they are seeking and providing the general location of the item relative to the area they just scanned with the RFID reader. As explained in more detail below, the RFID reader system uses different electromagnetic field configurations to achieve this objective to sense the general distance and angular orientation of the reader relative to the RFID-tagged items of interest to provide the user the general position of such items.

An RFID tag typically includes an integrated circuit operatively connected to an antenna that receives radio frequency (“RF”) energy from a source and backscatters RF energy in a manner well known in the art. The backscattered RF energy provides a signal that the RFID tag modulated to communicate information about the RFID tag and its associated article. An RFID-tagged item, as the term is used herein, including the claims, refers to an RFID tag that is somehow associated with an item. For example, it may be attached to the item, with adhesive, or built into the item, such as a file, or it may be located proximate to the item.

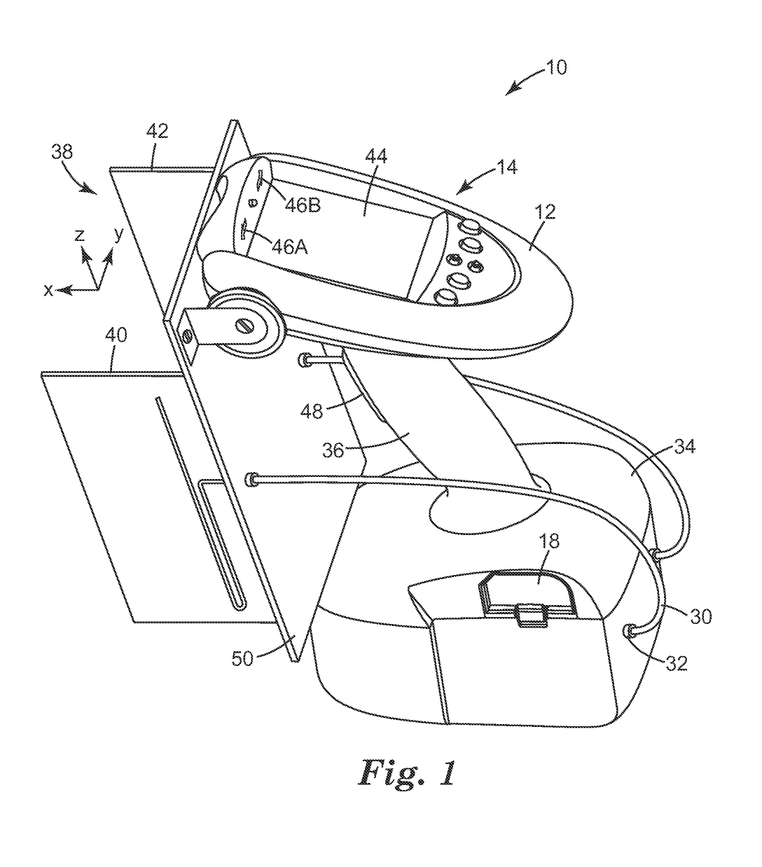

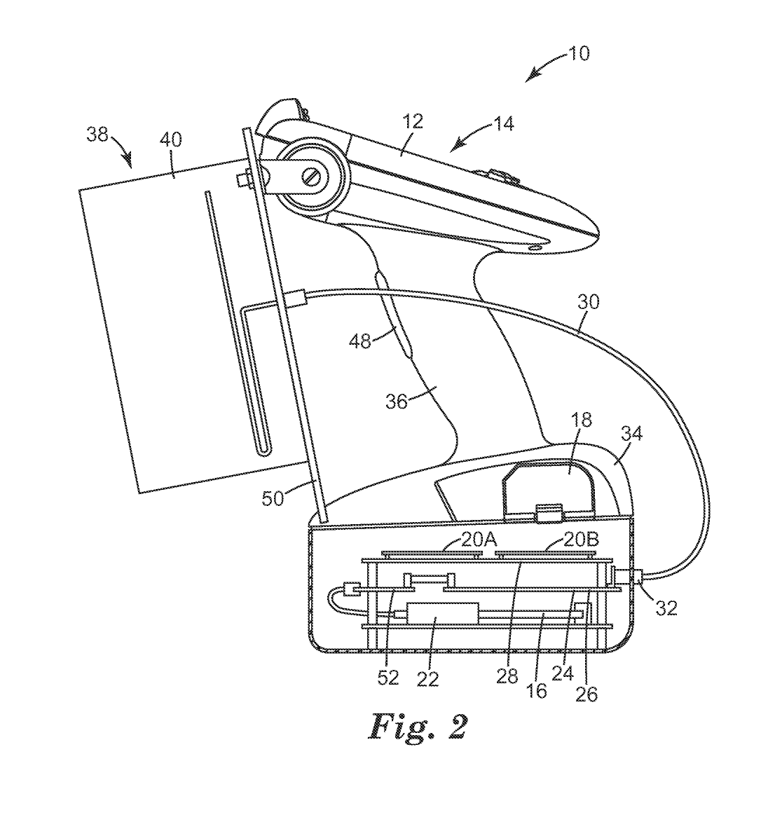

FIGS. 1 and 2 illustrate one embodiment of the RFID reader system of the present invention. RFID reader system 10 illustrates a portable or mobile RFID reader system. While FIG. 1 illustrates an embodiment that may be held by a user's hand, making it handheld, other configurations are imagined which make the system portable. For example, the RFID reader system 10 could be mounted on a moveable cart.

Referring both to FIGS. 1 and 2, RFID reader system 10 of the present invention preferably includes a computer 12, a user interface 14, an RFID reader 16, and an antenna 38. Preferably, the computer 12, user interface 14, RFID reader 16 and antenna 38 are all provided in a single integrated unit, as shown in FIGS. 1 and 2. Preferably, the antenna 38 is an array of antenna elements. In FIGS. 1 and 2, the RFID reader system 38 is illustrated as including two antenna elements, a first antenna element 40 and a second antenna element 42. The user interface 14 for the system is designed to communicate the status of searching and optionally to allow the user to enter data. One example of the user interface 14 is illustrated as including a display 44 and indicator lights 46A and 46B, which are useful for guiding the user to a particular item. However, the user interface 44 may take many forms; for example, the user interface may include various feedback systems, including audible indicators, such as particular sounds, or tactile or tactual indicators, such as vibrations, which direct a user to the particular item. The user interface 44 may include a keypad to allow a user to input information into the RFID reader system 10, may include keys for moving a cursor up and down to select an item listed on the display, or may include a touch-screen display. The user interface could include audio signals that are produced repeatedly at a desired interval to pace a user as to the speed at which RFID tags should be interrogated by the interrogation source or to indicate the proximate location of the RFID tags to the reader 10. The user interface 44 may either be integrated into the unit or separated. When separate, it can be designed in various ways, including as a “wearable” device that can be easily viewed, felt, or heard by the user.

The reader system 10 also preferably includes an RFID writer, a power source 18, and software to enable various functions of the types described herein. The RFID reader/writer could consist of a reader commercially available from WJ Communications, Inc. of San Jose, Calif. under part number MPR7000. The computer may be provided by, for example, a “palm-top” or handheld computer available from 3Com Company of Santa Clara, Calif. under the designation Palm Pilot. Alternatively, the computer may be similar to that commercially available from 3M Company, St. Paul, Minn. as the 3M 803 RFID reader system. The portable computer may include an operating system, a touch-screen display, several buttons for developing user interfaces, a recharge station, a docking station to transfer data between the system and another computer, one or more ports to connect peripherals to the portable RFID reader system and a battery power supply 18. Some units may also include a built-in peripheral such as a bar-code scanner. The Finder was based on the 3M

By using portable computer such as the Palm Pilot described above or other PDA, a number of real-time functions of the type described below can be achieved, in contrast to systems in which the RFID reader system must interact with a separate computer, database, software system, and the like.

The RFID reader system also preferably includes an integral power source, although it can be tethered to a larger power source of the type that might be worn around a user's waist. In the case of an integral power source, the source may or may not power the processor, and may be recharged when connected to a docking station. When a hand-held computer is used, it may include its own power source, and may be recharged when connected to the docking station to upload and/or download information.

There are a number of options for transferring data between the portable RFID reader system 10 and another processing station. A docking station approach can be used to upload or download data. This method could be used, for example, to upload item identification information prior to performing a search to find those specific items. The link could be implemented as a docking station; as a wireless or cabled download and/or upload; as a wireless or cabled, real-time link between the RFID reader system 10 and another processor, or in any other manner suitable for transferring such data.

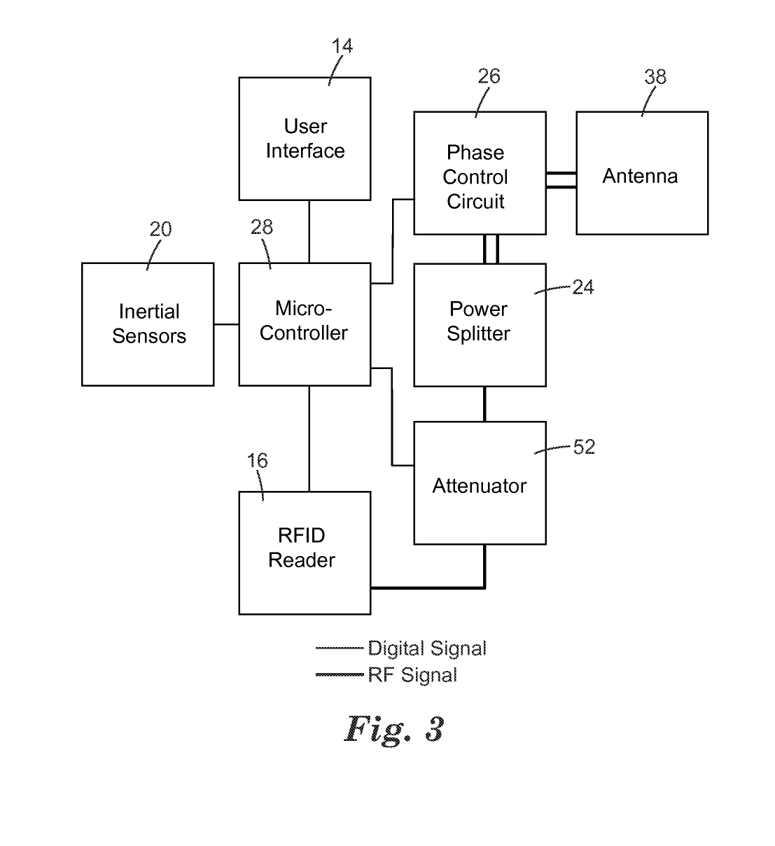

The RFID reader system 10 preferably includes a support member 50 for supporting the antenna elements 40, 42, a handle portion 36, and a base portion 34. The user interface 14 and computer 12 are mounted atop the handle portion 36. The base portion 34 includes multiple components mounted therein: voltage or power regulator 22, inertial sensors 20, power splitter 24, phase control circuit 26, microcontroller 28, attenuator 52, and a power source, such as a battery 18. FIG. 3 provides a block diagram for most of these components, which is convenient for describing how the RFID reader 16 and antenna 38 interconnect. To interconnect the RFID reader 16 to the two antenna elements 40, 42, the signal from the RFID reader 16 is divided with a power splitter 24, which is then connected to a phase control circuit 26, which in turn is connected to the two antenna elements 40, 42. This configuration serves as both the transmit and receive signal path of concurrently.

The RFID antenna elements 40, 42 of antenna array 38 are preferably spaced ½ wavelength apart. In one embodiment, the antenna elements used are 915 MHz yagi antennas. Such antennas included a director, a reflector and driven components. One example of commercially available yagi antennas are available from Ramsey Electronics, These were purchased as part number LPY915 from Ramsey Electronics, based in Victor, N.Y., available at http://www.ramseyelectronics.com. U.S. Pat. No. 6,307,521 discloses an impedance match to the driven component.

The RFID reader system 10 preferably includes at least one inertial sensor 20, which assists in calculating the general heading, bearing, route or position of the RFID tagged item of interest relative to the antenna 38. The inertial sensor 20 is an angular rate sensor sensitive to rotating in the horizontal plane (x-y plane), where the velocity signal is integrated once to yield the relative angular orientation in the horizontal plane. Note that the angular rate sensor alone is not able to determine absolute angular orientation, such as North or West, but it can determine how many degrees it is rotated and whether that angular motion is in a clockwise or counterclockwise direction. The use of more than one inertial sensor 20 would assist in providing a more definitive position. One example of a suitable inertial sensor is commercially available from Analog Devices, Inc. of Norwood, Mass., as part number ADIS16100. Currently available inertial sensors are not yet capable of determining precise or exact positions of the RFID-tagged items of interest, but as technology improves over time, it is expected that precision will increase. However, current commercially available sensors can provide a wide variety of general direction of the RFID-tagged item of interest relative to the RFID reader system 10 to provide a general heading, bearing, route or position of the RFID tagged item of interest, which assists the user in locating the RFID-tagged object of interest. One skilled in the art may choose a commercially available inertial sensor appropriate for the preciseness or exactness of the location that is desired for any particular application.

In one preferred embodiment, the RFID reader system 10 is configured to operate in an ultra high frequency (UHF) band of the radio spectrum. However, the RFID reader system 10 may be configured to operate in other frequency bands of the radio spectrum, such as high frequency.

The portable RFID reader system 10 can interrogate and identify RFID-tagged items whenever it is activated within range of the items, if the RFID tagged item is within the lobe or null field arrangement, as discussed in more detail below. Intermittent activation can be provided by, for example, a trigger 48 associated with the system, so that the elapsed time for which power is required for the RFID system 10 is minimized. The reading distance is a function of many factors, but is expected to be up to 30 inches (9.14 meters) given current technology and the likely frequencies at which the system would operate. In some applications, it may be desirable to restrict the operating range of the device so that it only interrogates RFID tags associated with items at a closer range. Preferably, as the RFID reader system 10 approaches the RFID-tagged item of interest, the output power decreases. In other cases, the longest available range of operation will be desired. In other applications, it may be preferred to control the output power (and thus the reading range) to permit longer continuous operation from the battery pack. The read range will also be influenced by the design of the antenna as well as the orientation of the RFID tag relative to the antenna. It should be appreciated that the read range, battery weight, and lifetime between battery recharges or replacement are often dependent on each other. Various tradeoffs can be envisioned, based on the particular application for the device.

In operation, a particularly useful feature of a portable system is obtaining real-time information regarding an item that has been scanned by the reader system 10. That is, the portable RFID reader system obtains information from the RFID tag, and either immediately displays that information, or immediately displays information stored within the system that is related to the tagged item. This is in contrast to devices that must be docked with or otherwise communicate with a separate database of information before that information can be displayed for the user. The portable RFID reader system of the present invention can also be docked or can otherwise communicate with a separate database, if such features are desired.

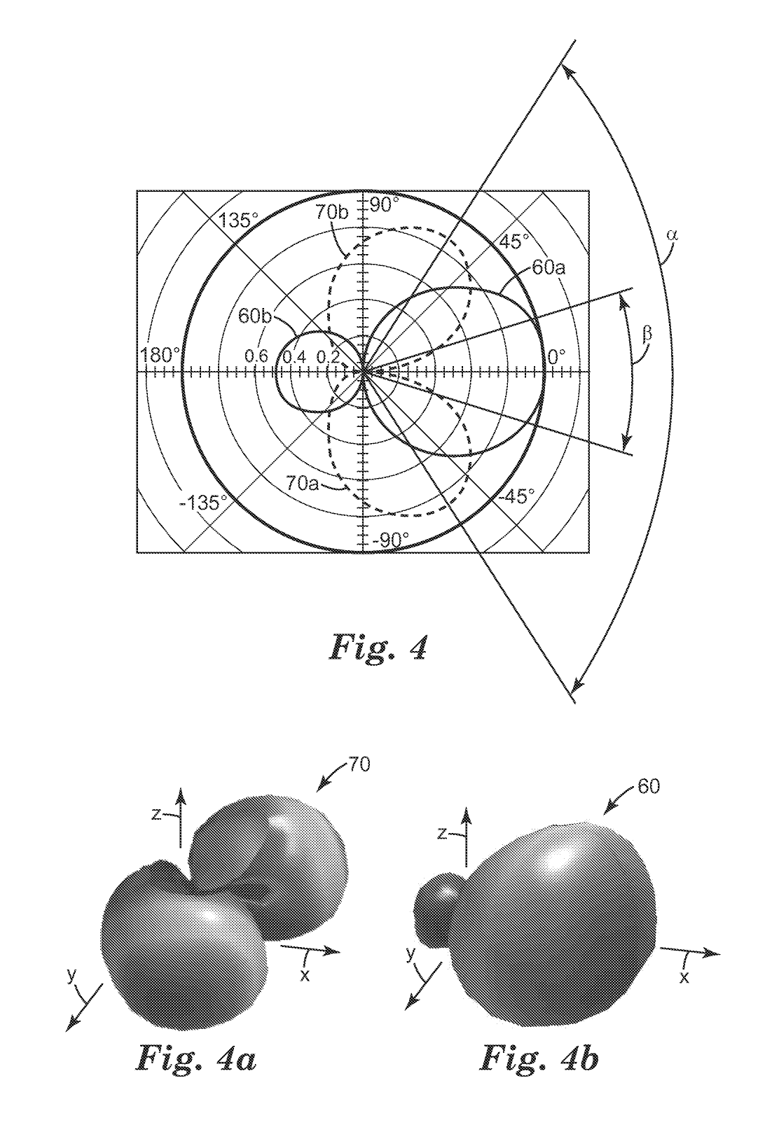

FIGS. 4, 4a and 4b are convenient for describing the various field configurations generated by RFID reader system 10. FIG. 4 is a two-dimensional antenna pattern illustrating actual test data of the electromagnetic fields created by the RFID reader system 10 of the present invention, including one embodiment of a null field configuration 70 and one embodiment of a lobe field configuration 60, through the x-y plane. FIGS. 4a and 4b illustrate a three-dimensional surface representation of the same electromagnetic fields of FIG. 4, where FIG. 4a represents the null field configuration 70 and FIG. 4b represents the lobe field configuration 60. (FIG. 4a illustrates a partial surface representation of the antenna pattern.) The lobe and null configurations are useful for identifying the location of RFID-tagged items, as described in more detail below.

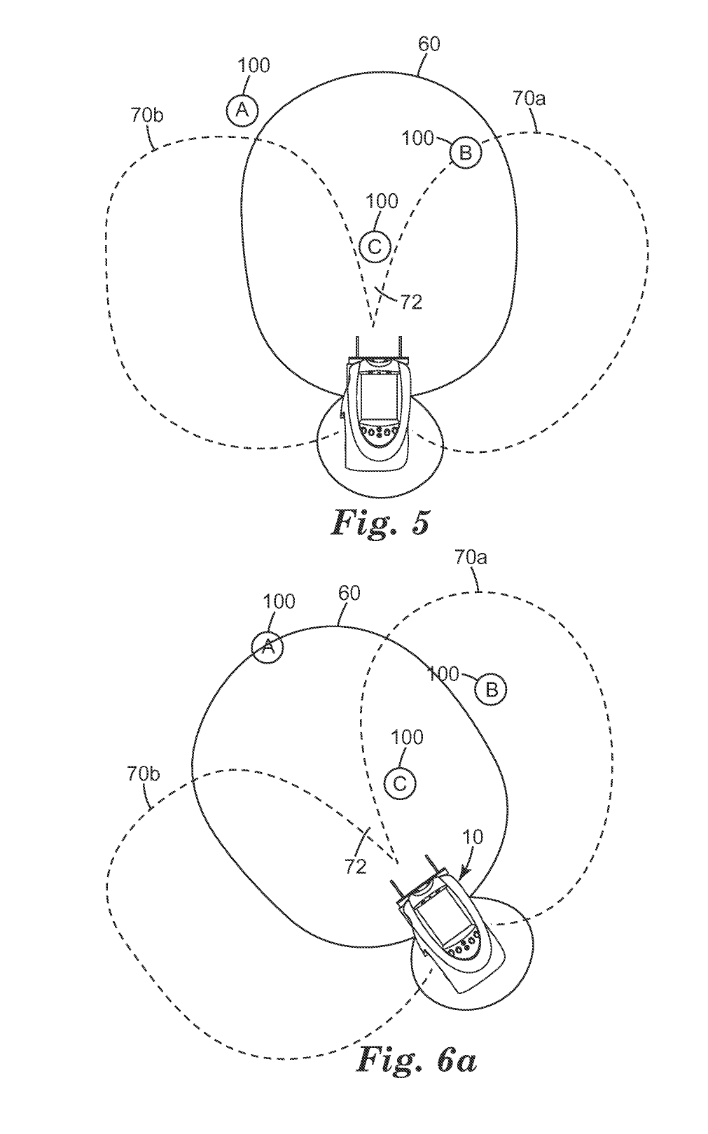

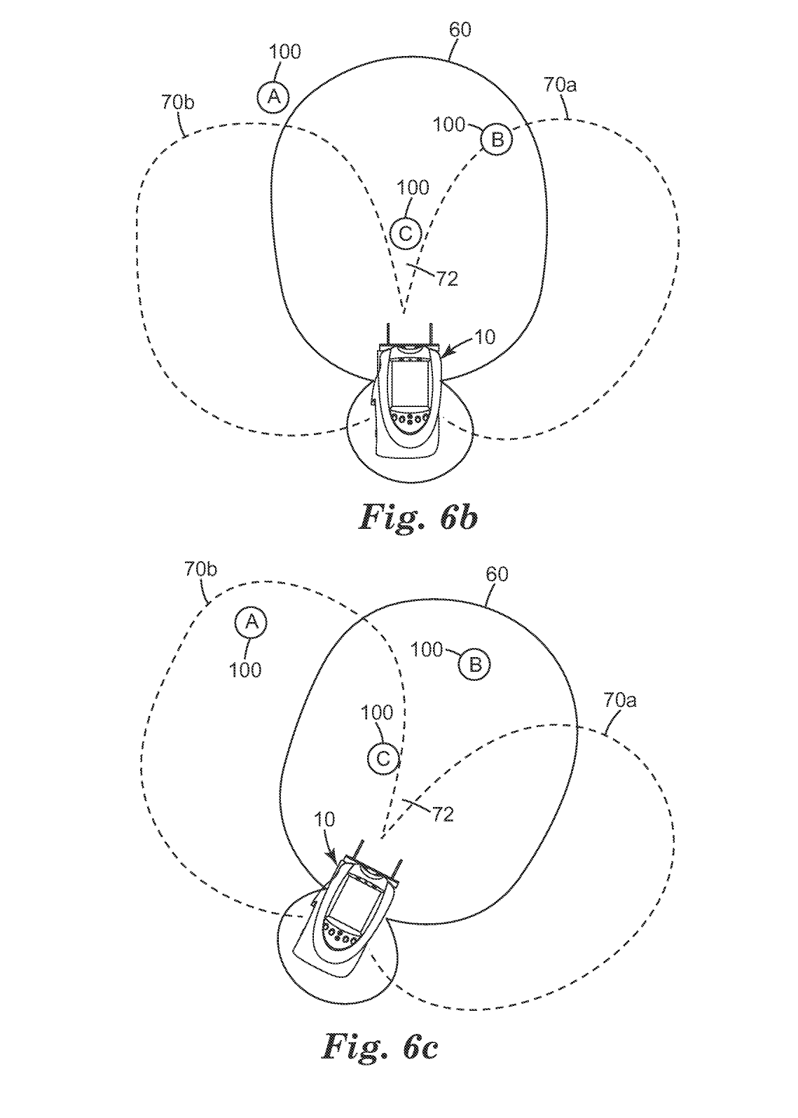

It is often convenient for portable RFID devices to be physically small, thus improving the portability of the RFID device. However, when the antenna is electrically small relative to the wavelength being used, the antenna will not be very directive. Generally, directivity is proportional to antenna size for a given frequency. Such electrically small antennas are useful to detect the presence or absence of an item, but not useful to provide general direction where to find the item. As used herein, the term electrically small refers to an antenna with a physical dimension of 1/10 or less of the wavelength being used. Larger antennas can have greater directivity than smaller antennas. An electrically large antenna with higher directivity can be created with an array of electrically small low directivity antennas as elements in the array. As in the present invention, an antenna of greater directivity is created by forming an array of smaller antennas to create a larger antenna. The spacing and relative phasing of the RF array elements 40, 42 are important factors in determining the performance of the antenna array 38. The phase of the RF elements 40, 42 can be electronically controlled, and such an antenna array 38 is commonly referred to as a “phased array antenna.” In one embodiment, the RF array elements are preferably spaced ½ to 1 wavelengths apart for optimal performance. In one embodiment, the antenna elements 40, 42 are spaced ½ wavelength apart in the y direction. Thus, as the number of antenna elements in the array 38 increase, the size of the antenna 38 increases, and generally improves the directivity of the antenna. When referring to increasing the directivity of the antenna, it is meant to say that the angular width of the main lobe field of the antenna is decreased. One example of such an angular width of the main lobe field is illustrated in FIG. 4 as angle α, where angle α represents the half-power angular span of the lobe field arrangement. In one embodiment angle α is approximately 115°. However one skilled in the art may choose other angles depending on the application desired. The main lobe field is designated with reference number 60a and the minor lobe field is designated with reference number 60b in FIG. 4. The main lobe field is typically directly in front of the antenna 38, and the minor lobe field is directed typically in back of the antenna 38. In a preferred embodiment, the minor lobe 60b is minimized or eliminated. Antenna arrays can also be designed to have nulls, or angular regions in which the antenna is not effective at radiating or receiving RF signals. One example of a null field configuration is illustrated in FIG. 4 with one lobe portion designated 70a and another lobe portion designated 70b to provide null 72. In a preferred embodiment, the angular null regions 72 can be narrow relative to the angular width of the main lobe. One example of such an angular width of the main null field is illustrated in FIG. 4 as angle β, where angle βrepresents the half-power angular span of the null field arrangement. In one embodiment angle β is approximately 35°, however one skilled in the art may choose other angles depending on the application desired. The present invention is designed to take advantage of the higher angular resolution of the null to provide an advantage when attempting to find the angular location of an RFID-tagged item, as described in more detail below in reference to FIGS. 5 and 6A-6C. An antenna array with as few as two elements can be used to create a lobe field configuration 60 or a null field configuration 70, depending on the relative phase of the two antenna elements 40, 42. When the two antenna elements 40, 42 are driven in phase, a lobe field configuration 60 is created. When the two antenna elements 40, 42 are driven out a phase, a null field configuration 70 having a null 72 is created, where the null is preferably of a smaller angular span (angle β) than the angular span (angle α) of the lobe field 60a, as illustrated in FIG. 4. When the null 72 is formed, it is actually bound by two lobes 70a and 70b, angularly offset to each side of the null 72. While either configuration alone may not be optimal for use with a portable RFID reader, the ability to rapidly switch electronically from one configuration to the other provides advantages. These advantages could include the ability to initially detect an RFID-tagged item using the lobe or null antenna configuration, and using the higher angular resolution of the null to aid in identifying the angular location of the item, as described in more detail below in reference to FIGS. 5 and 6A-C.

FIG. 5 illustrates the portable RFID reader system 10, representative RFID tags 100 in three different locations relative to the reader system labeled positions A, B and C, and a representation of the null field 70 and lobe field 60 that are created by the antenna 38. While typically only one of these fields can be created by the antenna 38 at any point in time, the phase control circuitry 26 can be electronically controlled to rapidly switch from one field to the other. The phase control circuitry 26 is under the control of the microcontroller 28, which allows the microcontroller 28 to select the null field configuration 70 or lobe field configuration 60. When the lobe field 60 is selected, the RFID tags 100 at positions B and C will be read, while the tag at position A will not be read. When the null field is selected, RFID tag at position B of FIG. 5 will be read, while the tags 100 at positions A and C will not be read. Based on this information, it can be determined that: 1) RFID tag C is generally center forward of the antenna 38 of the system 10 within read-range because it can be read with the lobe field 60 but not with the null field 70; 2) RFID tag B is to the off-center forward left or right of the antenna 38 within read range because it is read with both the null and lobe fields; and 3) the tag at position A is not within the read range of the antenna. Without additional information, it is not possible for the RFID reader system 10 to determine if RFID tag B is to the left or right of center. As a relative reference angle, consider the center forward direction towards tag C to be a reference angular orientation of 0 degrees.

FIG. 6 is convenient for indicating how the relative angular positions of these three RFID tags 100A-100C can be more uniquely determined if the antenna is rotated causing the fields to sweep through a general arc. FIGS. 6a-6c illustrate the fields as the RFID reader system 10 is swept from left to right, in three different positions. When the antenna is rotated counterclockwise about 15 degrees from the reference angular orientation of 0 degrees, as illustrated in FIG. 6a, the lobe field 60 will read RFID tag A, but the null field 70 will not. This information along with the angular information from the inertial sensor 20 can then be used to infer that the location of RFID tag 100A is at a heading of about 15 degrees to the left of the heading to RFID tag 100 C which was previously determined to be at a heading of approximately center forward, which was arbitrarily defined to be a reference angle of 0 degrees. From this orientation, as the antenna 38 is rotated clockwise, the antenna 38 is eventually again swept through a relative angle of 0 degrees, as illustrated in FIG. 6b. While the antenna 38 is swept through this angular position in FIG. 6b, the lobe field 60 will be able to read tag C, but the antenna 38 as it is generating the null 72 will not, verifying that tag C is still at a relative heading of about 0 degrees. As the antenna continues to rotate clockwise and sweeps through a relative angle of about 10 degrees to the right of the 0 degree reference angle, as illustrated in FIG. 6c, the lobe field 60 will be able to read tag B, but the lobes 70a, 70b of the null field 70 will not be able to read RFID tag 100B. Thus, when the RFID reader system 10 reads a particular RFID tag 100 with the lobe field 60, but not the null field 70, then that particular RFID tag 100 must be generally center forward of the antenna 38. This information coupled with the angular orientation of the antenna 38, as derived from the inertial sensor 20, enable the microcontroller 28 to determine the relative angular heading to various RFID tags 100 that are within the read range of the RFID reader system 10.

If only a wide lobe field 60 was used without a narrow null field 70 and without an inertial sensor 20, and the an RFID reader was designed to beep whenever the RFID tag 100 of interest was read, a user could use the portable RFID reader much like a Geiger counter to find the location of a single specific tag. However, because the wide lobe 60 would not be able to provide concise directional information, the RFID tag location process would not be optimal, compared to the information provided by the RFID reader system of the present invention. The ability to simultaneously locate several RFID tags 100 with an RFID reader could become very difficult if the RFID tags 100 of interest were in various direction, because then the reader would beep in response to finding one of the tags of interest when pointed in most any direction, confusing the user. The addition of a inertial sensor 20 and a microprocessor or microcontroller 28 that could correlate which RFID tag or tags were read at which angular orientations helps determine a general angular direction, or heading, in which each RFID tag of interest is located, especially after the antenna 38 is rotated through a full 360 degree sweep, assuming the RFID tags 100 were within read range of the antenna 38. The angular heading information for each of the RFID tags of interest could be presented to the user via a graphical or acoustic user interface.

If only a null field 70 were used without an inertial sensor 20, and a RFID reader that was designed to beep or provide a tactile sensation whenever the RFID tag 100 of interest was read, the user would likely be confused because the reader would beep only when the reader was not pointing directly at the RFID tag 100 of interest. This process would also be further confusing if the user was attempting to simultaneously identify the location of several RFID tags 100 located in various directions, which would also cause the RFID reader 10 to beep when pointed in almost any direction. In this scenario, the addition of an inertial sensor 20 and a microcontroller 28 are of great benefit. As the reader antenna 38 is rotated, the null field 70 sweeps through an arc. The inertial sensor 20 provides angular orientation information to the microcontroller 28. The microcontroller 28 then correlate this information to determine in which angular orientations each of the various RFID tags 100 could and could not be read. Knowing that as the antenna 38 is rotated continuously in one direction, each tag of interest would first be read prior to being in the null 72, and then not read while positioned in the null 72, and then read again once outside of the null 72, the system 10 determines when each of the RFID tags were in the null 72, that is, positioned directly forward of the antenna 38. Because the inertial sensor 20 can sense the direction of rotation, the microcontroller 28 accurately processes the data even if the user chose to sweep the reader antenna 38 in a back and forth motion rather than in a continuous rotation in a single direction.

Because the angular directivity of the null field 70 is greater that the angular directivity of the lobe field 60, it is advantageous to use the null field 70 to determine the angular direction of RFID tags 100 of interest. The difficulty of this arrangement, however, is that the RFID tag 100 can not be read when it is directly ahead of the antenna 38 because it is positioned in the null 72. Thus, it is advantageous to provide the RFID reader system of the present invention with an antenna 38 that can also create a lobe field 60 is to verify that the RFID tag 100 of interest is actually positioned generally forward of the antenna 38.

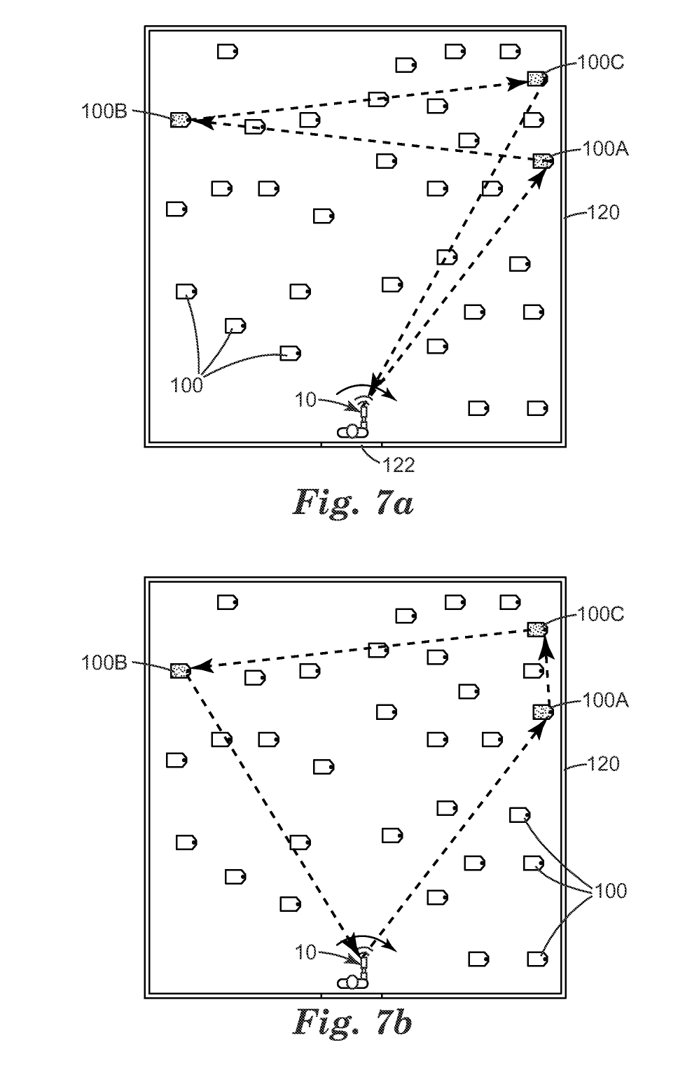

Once the RFID reader system 10 has identified the angular orientation of the RFID tags 100 of interest, the user interface 14 then directs the user in the direction of the tags, for example, as illustrated in FIG. 7a.

If the microcontroller 28 also varies the RF output power of the reader system 10, then the microcontroller 28 can also correlate at what RF power, as well as at what angular orientation each RFID tag 100 of interest was read, from which range and angular location information can be inferred. The RF power can be varied during the data acquisition process of a sweep or while being directed toward a tag of interest by the user interface 14. For instance, if the RFID reader system 10 provides tactual or audio indicators which vary depending on how close the reader 10 is to the object of interest 100.

During the sweep process, the RFID reader system 10 may also be accumulating an inventory of RFID tags 100 read, and accumulate location information for each of these RFID tags 100 for potential future use.

One example of using the RFID reader system 10 is illustrated in regards to FIGS. 7a and 7b. FIGS. 7a and 7b illustrate a person's office 120 or a room having a variety of RFID tagged items designated with reference number 100. For example, office 120 could be an attorney's office with several files each having their own RFID tag 100. As another example, room 120 could be the medical records room in a clinic where the medical records are RFID-tagged, or a warehouse with RFID-tagged pallets. Continuing with the example where room 120 is an attorney's office, the attorney's assistant enters the attorney's office 120 to retrieve a number of files 100 with RFID tags. The RFID tags each have their own identification number and each RFID tag is identified in a database and correlated with the particular file that that particular RFID tag is attached to. The assistant picks out what files she is seeking from the database, or directly from the portable RFID reader system 10 itself. She then enters the office to begin locating and collecting the files, and as she stands by the doorway 122, she sweeps the RFID reader system 10 in an arc, moving left to right, as illustrated by FIG. 7a, scanning the room 120 with the electromagnetic energy generated by the RFID reader system 10. At first, the RFID reader system 10 uses a field that is far reaching, achieved in part by using the antenna 38 with maximum RF power to determine the presence or absence of the items of interest 100 A-100C. During this phase, the antenna pattern may be narrow or may be wide, because the intent of this phase is not necessarily to resolve any information other than the simple presence or absence of the items of interest 100A-C. If none of the items of interest 100A-C are detected, then the assistant may search in another attorney's office or other location for the files she is seeking. However, if any of the items of interest 100 are detected, the antenna 38 starts the next phase of electronically switching back and forth between the various lobe and null fields discussed in detail above to start determining the relative location of each of the items of interest 100A-C relative to the reader system 10. Alternatively, instead of the RFID reader system 10 operating in these two separate and distinct modes, the system 10 may have one mode where the antenna is electronically switching back and forth between the lobe and null fields, and it determines the presence or absence of the items of interest 100A-C and determines the relative location of the items 100A-C at the same time. The display 44 of the user interface 14 may offer the user a visual depiction of the room that looks similar to the view illustrated in FIGS. 7a, 7b to provide general direction to each of the items of interest 100A-C. The items of interest 100A-C may then be collected in the order they were first selected by the user, as indicated by the dashed arrows in FIG. 7a. Alternatively, the RFID reader system 10 may include additional functionality in its software that calculates the approximate distance to the items of interest 100A-C from the reader and between the items of interest themselves, and then optimizes the travel distance between the three items of interest 100A-C. For instance, from a time perspective, it might be more efficient for the assistant to collect the items in order of 100A, 100C and 100B, as illustrated in FIG. 7b, in contrast to collecting the items in order of 100A, 100B, 100C, as illustrated in FIG. 7a.

In another embodiment, for general inventory purposes, if a location RFID tag were used, for instance an RFID tag in a fixed position designating room 120, the user could read the RFID location tag before entering the room, and the inertial sensors 20 could be zeroed out to represent the origin (0,0,0) point. Then, from this location, as the user moves through the room 120, the item RFID tags 100 could be read and a general location (x,y,z) could be associated with the item RFID tag 100 read to build up a database of information. This database could be constructed while inventorying through a wireless link or by docking after completion of the inventory. This way after all the rooms of interest have been put in the database, this feature could aide in the finding process. When an item is selected, the operator would know what room 120 to go to. After reading the location tag, they could be guided to the location in the room using the inertial sensors and from this location, the finder algorithm could get them the rest of the way.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A portable radio frequency identification (“RFID”) reader system for assisting a user in locating at least one RFID-tagged object of interest, comprising:
a computer;
a user interface;
an RFID reader; and
an antenna for creating an electromagnetic field, wherein the antenna can electronically switch between a lobe field arrangement and a null field arrangement to determine the existence and the general location of an RFID-tagged object of interest.

2. The portable RFID reader system of claim 1, wherein a half-power angular span of the null field arrangement is less than a half-power angular span of the lobe field arrangement.

3. The portable RFID reader system of claim 1, wherein an operating range of the reader is restricted by controlling the output power of the RFID reader.

4. The portable RFID reader system of claim 3, wherein the computer determines if the distance between the antenna and the RFID-tagged object of interest is increasing or decreasing.

5. The portable RFID reader system of claim 1, further comprising at least one inertial sensor.

6. The portable RFID reader system of claim 5, wherein the computer determines the relative angular direction between the antenna and the RFID-tagged object of interest.

7. The portable RFID reader system of claim 1, further comprising at least one inertial sensor, wherein an operating range of the reader is restricted by controlling the output power of the RFID reader, and wherein the computer gathers data regarding the power setting and regarding the inertial sensor to estimate the general distance between the antenna and the RFID-tagged object of interest.

8. The portable RFID reader system of claim 7, wherein the computer determines the position of a plurality of RFID-tagged items of interest relative to the antenna, and determines an order for traveling to all of the plurality of items of interest that minimizes travel distance between all the plurality of items.

9. The portable RFID reader system of claim 1, wherein the user interface comprises a visual, an audio or tactual indicator for providing information to the user.

10. The portable RFID reader system of claim 9, wherein the system communicates the status of searching, and wherein the user interface permits a user to enter data into the RFID system.

11. The portable RFID reader system of claim 1, wherein the user interface includes a display and indicates the relative location of the RFID-tagged item of interest.

12. The portable RFID reader system of claim 1, wherein the antenna comprises an antenna array for creating an electromagnetic field, wherein the antenna array comprises a first radio frequency (“RF”) element and a second RF element, wherein the first RF element and the second RF element are driven in phase to create a lobe field arrangement, and wherein the first RF element and the second RF element are driven out of phase to create a null field arrangement.

13. A portable radio frequency identification (“RFID”) reader system for assisting a user in locating at least one RFID-tagged object of interest, comprising:
a computer;
a user interface;
an RFID reader;
an antenna array for creating an electromagnetic field, wherein the antenna array comprises a first radio frequency (“RF”) element and a second RF element, wherein the first RF element and the second RF element are driven in phase to create a lobe field arrangement, wherein the first RF element and the second RF element are driven out of phase to create a null field arrangement, and wherein the antenna array can be electronically switched between the lobe field arrangement and the null field arrangement to determine the existence and the general location of an RFID-tagged object of interest.

14. The portable RFID reader system of claim 13, wherein a half-power angular span of the null field arrangement is less than a half-power angular span of the lobe field arrangement.

15. The portable RFID reader system of claim 13, wherein an operating range of the reader is restricted by controlling the output power of the RFID reader.

16. The portable RFID reader system of claim 15, wherein the computer determines if the distance between the antenna and the RFID-tagged object of interest is increasing or decreasing.

17. The portable RFID reader system of claim 13, further comprising at least one inertial sensor.

18. The portable RFID reader system of claim 13, further comprising at least one inertial sensor, wherein an operating range of the reader is restricted by controlling the output power of the RFID reader, and wherein the computer gathers data regarding the power setting and regarding the inertial sensor to estimate the general distance between the antenna and the RFID-tagged object of interest.

19. The portable RFID reader system of claim 17, wherein the computer determines the relative angular direction between the antenna and the RFID-tagged object of interest.

20. The portable RFID reader system of claim 18, wherein the computer determines the position of a plurality of RFID-tagged items of interest relative to the antenna, and determines an order for traveling to all of the plurality of items of interest that minimizes travel distance between all the plurality of items.

21. The portable RFID reader system of claim 13, wherein the user interface comprises visual, an audio or tactual indicator for providing information to the user.

22. The portable RFID reader system of claim 21, wherein the system communicates the status of searching, and wherein the user interface permits a user to enter data into the RFID system.

23. The portable RFID reader system of claim 13, wherein the user interface includes a display and indicates the location of the RFID-tagged item of interest.

24. A method of assisting a user in locating at least one RFID-tagged object of interest, comprising the steps of:
providing a portable radio frequency identification (“RFID”) system for assisting a user in locating at least one RFID-tagged object of interest, comprising:
a computer;
a user interface;
an RFID reader; and
an antenna for creating an electromagnetic field, wherein the antenna can electronically switch between a lobe field arrangement and a null field arrangement to determine the existence and the general location of an RFID-tagged object of interest;
determining the existence of an object of interest having an RFID tag associated therewith; and
electronically switching between the lobe field arrangement and null field arrangement to determine location of the object of interest having an RFID tag associated therewith.

25. A method of assisting a user in locating at least one RFID-tagged object of interest, comprising the steps of:
generating an electromagnetic field having a lobe field arrangement;
scanning a designated area;
determining an angular range over an RFID-tagged object of interest was read within the electromagnetic field;
determining that the RFID-tagged object of interest is approximately centered in the angular range.
